(19) United States
(12) Patent Application Publication
(10) Pub. No.: US 2017/0110255 A1
(43) Pub. Date: Apr. 20, 2017

(54) CATHODE SUBASSEMBLY WITH INTEGRATED SEPARATOR

(71) Applicant: Pacesetter, Inc., Sunnyvale, CA (US)

(72) Inventors: David R. Bowen, Taylors, SC (US); Thomas F. Strange, Easley, SC (US); Ralph Jason Hemphill, Sunset, SC (US)

(21) Appl. No.: 14/882,782

(22) Filed: Oct. 14, 2015

(51) Int. Cl. H01G 9/055; H01G 9/02; H01G 9/15

(52) U.S. Cl. CPC H01G 9/055; H01G 9/15; H01G 9/02

(57) ABSTRACT

Device designs are presented that include a cathode subassembly for protecting the device from unwanted discharge, and aiding in alignment of the cathodes and anodes within a device. A device includes a conductive anode, a dielectric material disposed on a surface of the conductive anode, a conductive cathode, and an electrolyte disposed between the anode and the cathode. The conductive cathode is sandwiched between two separator sheets, the two separator sheets being adhered together at a peripheral edge in an area outside of a perimeter of the conductive cathode.

### FIELD

The present invention relates generally to the field of electrolytic capacitors and batteries.

### BACKGROUND

Compact, high voltage capacitors are utilized as energy storage reservoirs in many applications, including implantable medical devices. These capacitors are required to have a high energy density, since it is desirable to minimize the overall size of the implanted device. This is particularly true of an Implantable Cardioverter Defibrillator (ICD), also referred to as an implantable defibrillator, since the high voltage capacitors used to deliver the defibrillation pulse can occupy as much as one third of the ICD volume.

Stacked electrolytic capacitors are typically constructed with a plurality of anodes and cathodes, which must be separated by a liquid absorbent insulative material, and are impregnated by an electrically conductive electrolyte. If the separator is not present as a line of sight barrier between any anode and adjacent cathode, there exists a danger of physical contact, as well as electrical breakdown of any incidental gasses present in the completed capacitor. Either of these scenarios would result in an undesirable partial or complete discharge event with a high probability of device failure.

Stacked electrolytic capacitors have utilized physical features in the constituent components of assembly with the aim of assuring precision of physical alignment such that the dimensions of those components leave physical margins that assure adequate separator coverage between all anodes and cathodes. Historically, those features have included holes in the separators, anodes, and cathodes in order to align with features on stacking fixtures when being assembled. These holes constitute undesirably lost surface area in each anode and cathode, which in turn requires compensation either in numbers of anodes and cathodes, or overall physical outline of those components in order to achieve a given design capacitance in the finished part.

The stacked alignment holes result in an undesirably larger overall finished part than would otherwise be required. The stacked alignment holes also create isolated cavities in the finished part which can lead to gas rich, electrolyte starved regions ripe for latent failure. The edges of the holes or other features necessarily create more edge length and complexity of shape for each anode, which increases the challenge of removing them flaw-free from the source anode sheet material.

### BRIEF SUMMARY

Device designs are presented that include a cathode subassembly for protecting the device from unwanted discharge, and aiding in alignment of the cathodes and anodes within a device.

According to an embodiment, a device includes a conductive anode (e.g., an anode foil), a dielectric material disposed on a surface of the conductive anode, a conductive cathode (e.g., a cathode foil), and an electrolyte disposed between the anode and the cathode. The conductive cathode is sandwiched between two separator sheets, the two separator sheets being adhered together along a peripheral area outside of a perimeter of the conductive foil.

According to an embodiment, a cathode for use in an electrolytic capacitor includes a conductive foil, a first separator sheet, and a second separator sheet. The first separator sheet has a shape corresponding to a shape of the conductive foil and is disposed over a first face of the conductive foil. The second separator sheet has a shape corresponding to the shape of the conductive foil and is disposed over an opposite face of the conductive foil. The first separator and the second separator are adhered together along a peripheral area outside of a perimeter of the conductive foil.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form part of the specification, illustrate a cathode assembly with an integrated separator and a capacitor formed therefrom. Together with the detailed description, the drawings further serve to explain the principles of and to enable a person skilled in the relevant art(s) to make and use the methods and systems presented herein. In the drawings, like reference numbers indicate identical or functionally similar elements. Further, the drawing in which an element first appears is typically indicated by the leftmost digit(s) in the corresponding reference number.

FIG. 1 illustrates a cross-section of an electrolytic capacitor or battery.

FIG. 2 provides a cross section of a cathode subassembly, according to an embodiment.

FIG. 3 provides an exploded view of the cathode subassembly, according to an embodiment.

FIG. 4 provides a perspective view of the cathode subassembly, according to an embodiment.

FIG. 5 illustrates a bulk separator sheet having a plurality of cells shown thereon, according to an embodiment.

### DETAILED DESCRIPTION

The following detailed description of capacitor and battery designs refers to the accompanying drawings that illustrate exemplary embodiments consistent with these devices. Other embodiments are possible, and modifications may be made to the embodiments within the spirit and scope of the methods and systems presented herein. Therefore, the following detailed description is not meant to limit the devices described herein. Rather, the scope of these devices is defined by the appended claims.

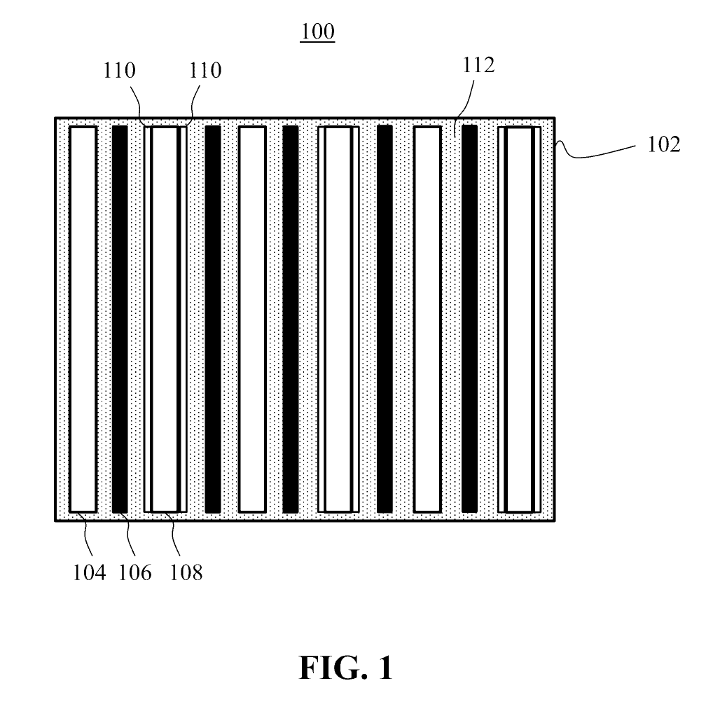

FIG. 1 illustrates a cross-section view of an electronic component 100. Electronic component 100 includes a housing 102 that contains a plurality of cathodes 104 alternating with a plurality of anodes 108, and separated by a plurality of separators (or spacers) 106. Each anode 108 includes a dielectric material 110 on or around an outer surface of anode 108. Dielectric material 110 may be an oxide that is thermally grown on, or deposited onto, the surface of anode 108. A high-k dielectric material may be used for dielectric material 110. A conductive electrolyte 112 fills the space between each of the elements within housing 102. Electrolyte 112 may be a polymer or liquid electrolyte as would be understood to one skilled in the art. Example electrolytes include ethylene glycol/boric acid based electrolytes and anhydrous electrolytes based on organic solvents such as dimethylformamide (DMF), dimethylacetamide (DMA), or gamma-butyrolactone (GBL). The plurality of cathodes 104 may be electrically connected to a single, common cathode terminal, while the plurality of anodes 108 may be similarly connected to a single, common anode terminal.

Electronic component 100 may be, for example, an electrolytic capacitor or a battery. When electronic component 100 is used as a capacitor, example materials for plurality of cathodes 104 include aluminum, titanium, stainless steel, while example materials for plurality of anodes 108 include aluminum and tantalum. When electronic component 100 is used as a battery, example materials for plurality of cathodes 104 include silver vanadium oxide, carbon fluoride, magnesium oxide, or any combination thereof, while example materials for plurality of anodes 108 include lithium metal.

Spacer 106 may be provided to maintain a given separation between each cathode 104 and an adjacent anode 108 within housing 102. Additionally, spacer 106 may be provided to prevent arcing between cathode 104 and anode 108 in spaces where dielectric 110 may be very thin or nonexistent, and/or where a void within electrolyte 112 exists between cathode 104 and anode 108.

Aligning each cathode 104, spacer 106, and anode 108 together in a stack is typically performed using physical features on each element that fit together (such as a peg-in-hole arrangement). As discussed above, this reduces the total usable surface area, which in turn reduces the overall energy density of electronic component 100.

It should be understood that the various elements and dimensions of electronic component 100 are not drawn to scale. Although each of cathode 104, separator 106, and anode 108 are illustrated as being apart from one another for the convenience of illustration and labeling, it would be understood by one skilled in the art that such elements may also be stacked together in close physical contact with one another.

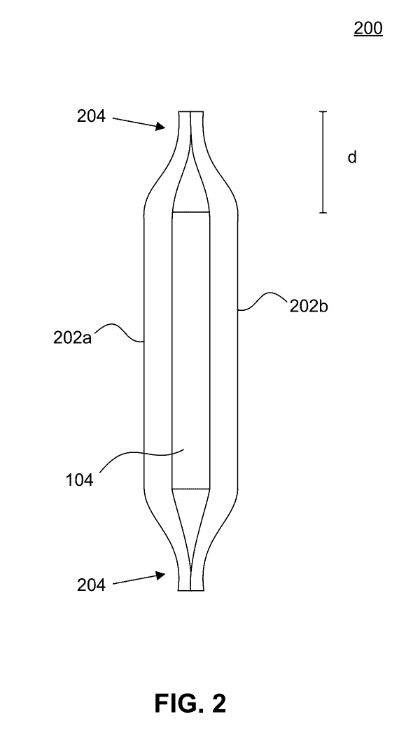

FIG. 2 illustrates a cross section of a cathode subassembly 200, according to an embodiment. Cathode subassembly 200 includes cathode 104 sandwiched between (i.e., contained within and substantially surrounded by) two separator sheets 202a and 202b. Separator sheet 202a is disposed across one surface of cathode 104, while separator sheet 202b is disposed across the opposite surface of cathode 104. Separator sheets 202a and 202b extend beyond the boundaries of cathode 104 by a distance d and are adhered together at location 204 along the edges of separator sheets 202a and 202b. In an example embodiment, where cathode 104 has dimensions of about 1.5 inches by 1.0 inches, distance d from an edge of cathode 104 to the edges of separator sheets 202a and 202b may be in a range between 15 thousandths of an inch (0.015) and 30 thousandths of an inch (0.030). According to an embodiment, the distance d is chosen such that it is close enough to the edge of cathode 104 in order to minimize the overall footprint, but is large enough to not comprise mechanical robustness or long-time reliability.

Each separator sheet 202a and 202b may include a high density Kraft paper. Other example materials include woven textiles made of one or a composite of several nonconductive fibers such as aramid, polyolefin, polyamide, polytetrafluoroethylene, polypropylene, and glass. Separator sheets 202a and 202b should be porous enough such that an electrolyte can penetrate through each separator sheet 202a and 202b. Any insulating material that can be formed into a uniform, thin sheet with a porous structure may be used for separator sheet 202a and 202b. The material preferably shows no dissolution or shrinkage when introduced to the electrolyte. Similarly, the material preferably does not elute any chemicals when introduced to the electrolyte that would damage any part of the device over time (e.g., corrosives or, in the case of aluminum electrolytic capacitors, halides.)

An adhesive may be used at location 204 to bond separator sheet 202a and separator sheet 202b together. Example adhesives include UV curable polymers, acrylic polymers, silicones, polyurethanes, polysulfides and cyanoacrylates. According to an embodiment, the adhesive does not dissolve in the presence of an electrolyte and does not elute any chemicals when introduced to the electrolyte that would damage any part of the device over time (e.g., corrosives or, in the case of aluminum electrolytic capacitors, halides.). The adhesive is selected and configured to provide a permanent bond between separator sheet 202a and separator sheet 202b, according to an embodiment.

By sandwiching cathode 104 between separator sheets 202a and 202b, the entire surface area of cathode 104 is still usable, thereby promoting a higher energy density due to elimination of alignment center holes and/or circumscribed alignment features on the cathode. Relative surface area increase may be as much as 2% to 5% depending of the cathode geometry, resulting in an increase of between 0.1 J/cc (Joules per cubic centimeter) and 0.25 J/cc delivered energy capacity. Separator sheets 202a and 202b around cathode 104 eliminate the need for separator 106 in FIG. 1.

It should be understood that only one cathode subassembly 200 is illustrated in FIG. 2 for simplicity, but each of cathodes 104 illustrated in FIG. 1 may be sandwiched between separator sheets 202a and 202b. According to an alternate embodiment, anode 108 may be sandwiched between separator sheets while cathode 104 is left bare. According to another embodiment, both cathode 104 and anode 108 are sandwiched between separator sheets.

In another embodiment, a single separator sheet is used to encapsulate cathode 104 rather than using two separate sheets. In this embodiment, the single separator sheet is folded in half, with each half forming one of separator sheets 202a and 202b in FIG. 2. The single separator sheet may be pre-folded prior to being used to sandwich cathode 104. Alternatively, the single separator sheet may be folded over an edge of cathode 104 to sandwich cathode 104 at the time of assembly. Thereafter, separator sheets 202a and 202b (i.e., the halves of the separator sheet formed by the fold) may be bonded together as discussed above. The bonding may be done in the areas along all peripheral edges, including the folded edge (i.e., the edge formed by the fold). Alternatively, the folded edge need not be separately bonded (e.g., using an adhesive), since the fold itself acts as a bond. As the term “bond” is used herein, it is intended to mean any means for joining sheets 202a and 202b, including a fold.

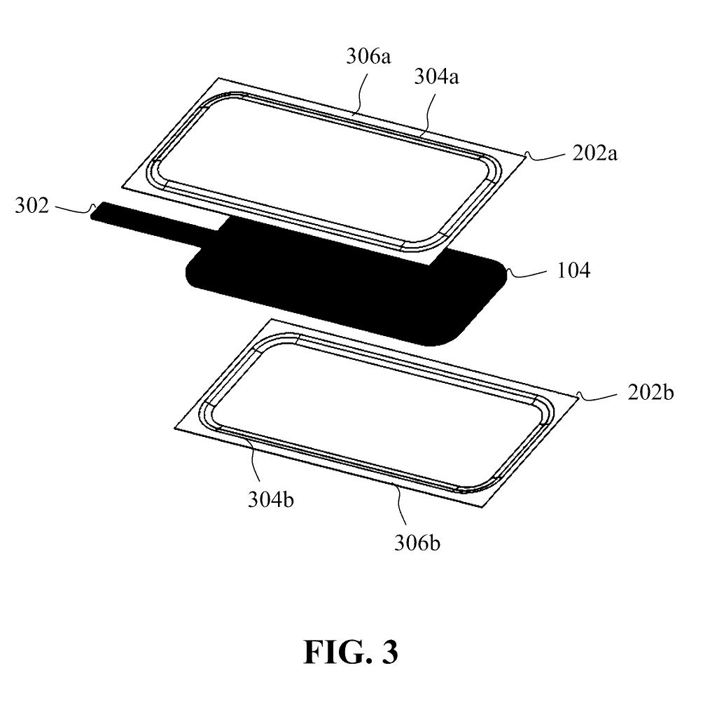

FIG. 3 illustrates an exploded view of separator sheets 202a and 202b being placed over cathode 104, according to an embodiment. Cathode 104 is illustrated having a generally rectangular shape with separator sheets 202a and 202b having a similar shape to sandwich (i.e., substantially enclose) cathode 104. It should be understood that other shapes may be used as well without deviating from the scope or spirit of the embodiments described herein.

Electrical connection is made to cathode 104 via terminal 302. Terminal 302 may be an extension of the material of cathode 104, or terminal 302 may be a different material that is bonded to cathode 104. Cathode 104 is commonly formed from a metal foil or plate, such as aluminum, titanium, or stainless steel. Cathode 104 may be any electrically conductive material that can be formed into a uniform, thin sheet. As used herein, the terms “foil,” “sheet,” and “plate” are used interchangeably to refer to a thin, planar material.

Separator sheets 202a and 202b include corresponding (i.e., mating) indentations 304a and 304b, according to an embodiment. Indentations 304a and 304b may be configured to closely mate such that cathode 104 is enclosed or encapsulated, when separator sheets 202a and 202b are brought together on opposite sides of cathode 104 with cathode 104 sandwiched there between. An area of indentations 304a and 304b may be designed to be slightly larger than an area of cathode 104 to provide some tolerance when aligning separator sheets 202a and 202b over cathode 104.

An adhesive may be used within edge regions 306a and 306b to bond separator sheets 202a and 202b together, according to an embodiment. Edge region 306a may include the area between indentation 304a and an outermost edge of separator sheet 202a. Similarly, edge region 306b may include the area between indentation 304b and an outermost edge of separator sheet 202b. Edge regions 306a and 306b exist beyond a perimeter of cathode 104. In one example, edge regions 306a and 306b completely circumscribe cathode 104. The adhesive that bonds separator sheets 202a and 202b may extend all the way to the edges of separator sheets 202a and 202b.

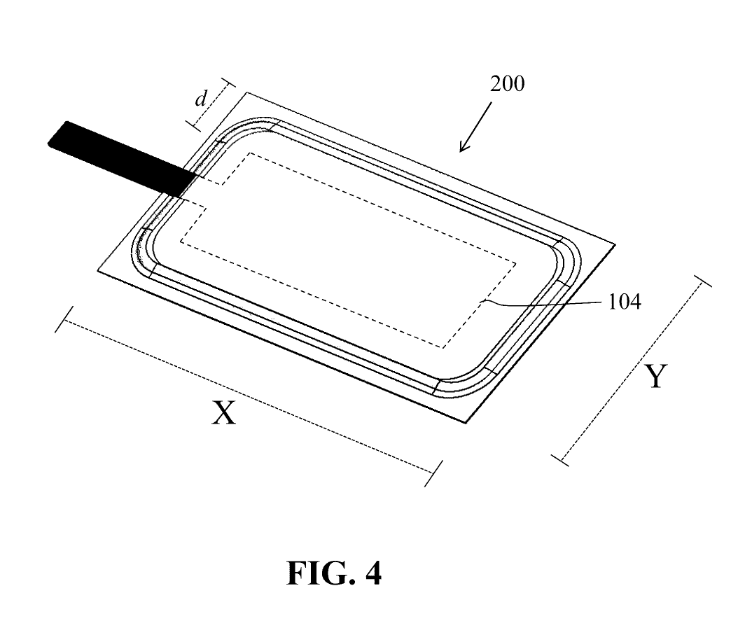

FIG. 4 illustrates another view of cathode subassembly 200, according to an embodiment. Cathode 104 is shown in phantom using a dotted line to illustrate that it is encapsulated between the two separator sheets. An example X dimension for cathode subassembly 200 is between one inch and two inches while an example Y dimension for cathode subassembly 200 is between 0.5 inches and 1.25 inches. The distance d is also illustrated and is the same distance d as that shown in FIG. 2.

According to an embodiment, each of the X and Y dimensions of cathode subassembly 200 is substantially the same as the X and Y dimensions of an anode that is stacked adjacent to cathode subassembly 200. This similarity in the footprint of each cathode subassembly 200 and each anode facilitates easier self-alignment of the various cathodes/anodes when constructing, for example, electronic component 100 of FIG. 1.

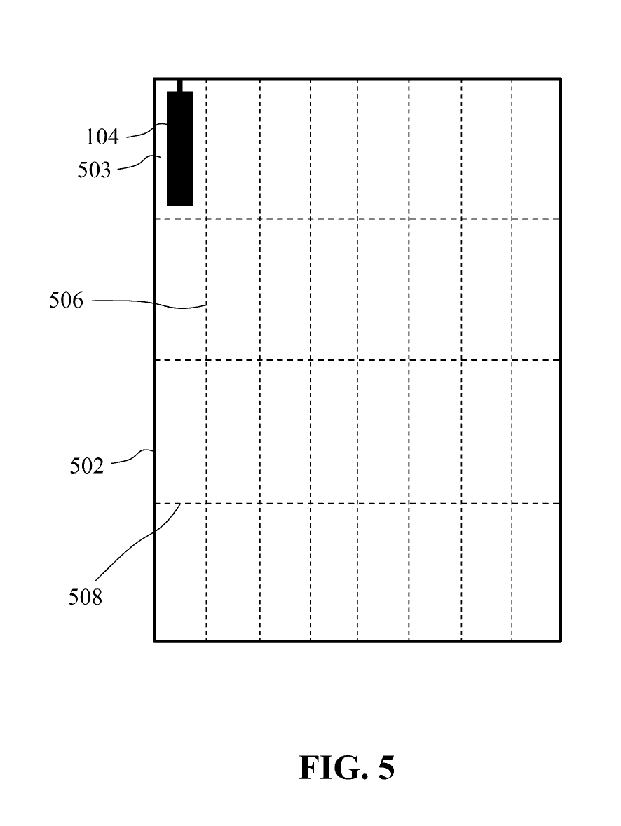

FIG. 5 illustrates a bulk separator sheet 502 having a plurality of cells 503 marked thereon, according to an embodiment. Bulk separator sheet 502 is the same material as, for example, separator sheets 202a and 202b. Each cell 503 may represent a single separator sheet. The various cells 503 are defined by vertical scribe lines 506 and horizontal scribe lines 508.

Provided herein is one example of fabricating a cathode assembly 200, with reference to FIG. 4. A cathode 104 is placed within cell 503. Any number of cathodes may be placed into any number of corresponding cells of bulk separator sheet 502. Once the cathodes are in place, an adhesive may be applied along the perimeter of each cell 503, generally in the area of vertical scribe lines 506 and horizontal scribe lines 508. A second bulk separator sheet (not shown) may then be aligned over bulk separator sheet 502 and bonded to bulk separator sheet 502 via the adhesive.

At this point, an array of cathode subassemblies are formed and connected together along vertical scribe lines 506 and horizontal scribe lines 508. Each subassembly may be removed from bulk separator sheet 502 by cutting along vertical scribe lines 506 and horizontal scribe lines 508 using any number of known techniques, such as mechanical shearing, cleaving, or laser cutting. According to an embodiment, cutting along vertical scribe lines 506 and horizontal scribe lines 508 also cuts through the adhesive bonding the separator sheets together.

In one embodiment, portions of separator sheets 202a and 202b that cover terminal 302 of cathode 104 are removed to permit electrical connection to cathode 104. In another embodiment, cathode 104 is positioned in a cell 503 such that a distal (i.e., distal from the body of cathode 104) end of terminal 302 extends out from cell 503 and is not covered by separator sheets 202a and 202b. This eliminates need to remove separator sheets 202a and 202b material from terminal 302 when it is making electrical connection thereto.

It is to be appreciated that the Detailed Description section, and not the Summary and Abstract sections, is intended to be used to interpret the claims. The Summary and Abstract sections may set forth one or more but not all exemplary embodiments of the present system and method as contemplated by the inventors, and thus, are not intended to limit the present method and system and the appended claims in any way.

Moreover, while various embodiments of the present system and method have been described above, it should be understood that they have been presented by way of example, and not limitation. It will be apparent to persons skilled in the relevant art(s) that various changes in form and detail can be made therein without departing from the spirit and scope of the present system and method. Thus, the present system and method should not be limited by any of the above described exemplary embodiments, but should be defined only in accordance with the following claims and their equivalents.

In addition, it should be understood that the figures, which highlight the functionality and advantages of the present system and method, are presented for example purposes only. Moreover, the steps indicated in the exemplary system(s) and method(s) described above may in some cases be performed in a different order than the order described, and some steps may be added, modified, or removed, without departing from the spirit and scope of the present system and method.

What is claimed is:

1. A device comprising:
a conductive anode;
a dielectric material disposed on a surface of the conductive anode;
a conductive cathode, wherein the conductive cathode is sandwiched between two separator sheets, the two separator sheets being adhered together along a peripheral area outside of a perimeter of the conductive foil; and
an electrolyte disposed between the anode and the cathode.

2. The device of claim 1, further comprising a plurality of conductive anodes arranged in a stack formation.

3. The device of claim 2, further comprising a plurality of conductive cathodes arranged in the stack formation in an alternating, interleaved arrangement with the plurality of conductive anodes.

4. The device of claim 3, wherein each of the plurality of conductive cathodes is sandwiched between two separator sheets, the two separator sheets being adhered together in an area outside of the perimeter of the corresponding conductive cathode.

5. The device of claim 1, wherein the two separator sheets are adhered together using an adhesive material.

6. The device of claim 5, wherein the adhesive material is configured not to dissolve in the electrolyte.

7. The device of claim 5, wherein the adhesive material extends to an outer-most edge of the two separator sheets.

8. The device of claim 1, wherein each of the two separator sheets includes a peripheral indentation that mates with a corresponding peripheral indentation on the other separator sheet when the two separator sheets are stacked together, the cathode being disposed within the peripheral indentations of the separator sheets.

9. The device of claim 1, wherein the conductive cathode and the two separator sheets form a cathode unit, the cathode unit having dimensions along two axes that are substantially the same as the dimensions of the conductive anode along two axes.

10. The device of claim 1, wherein the device is an electrolytic capacitor.

11. The device of claim 1, wherein the two separator sheets are each permeable to the electrolyte.

12. The device of claim 1, wherein a distance from an edge of the cathode to an edge of the two separator sheets is between 15 thousandths of an inch and 30 thousandths of an inch.

13. A cathode subassembly for use in an electrolytic capacitor, the cathode subassembly comprising:
a conductive foil;
a first separator sheet having a shape corresponding to a shape of the conductive foil and being disposed over a first face of the conductive foil; and
a second separator sheet having a shape corresponding to the shape of the conductive foil and being disposed over an opposite face of the conductive foil,
wherein the first separator sheet and the second separator sheet are adhered together along a peripheral area outside of a perimeter of the conductive foil.

14. The cathode subassembly of claim 13, wherein the two separator sheets are adhered together using an adhesive material.

15. The cathode subassembly of claim 14, wherein the adhesive material is configured not to be dissolved by an electrolyte.

16. The cathode subassembly of claim 14, wherein the adhesive material extends to an outer-most edge of the first and second separator sheets.

17. The cathode subassembly of claim 13, wherein each of the two separator sheets includes an indentation that aligns with a respective indentation of the other one of the separator sheets when the two separator sheets are stacked together, the cathode being disposed within the indentation of each separator sheet.

18. The cathode subassembly of claim 13, wherein the first and second separators comprise high-density craft paper.

19. The cathode subassembly of claim 13, wherein a distance from an edge of the conductive foil to an edge of the two separator sheets is between 15 thousandths of an inch and 30 thousandths of an inch.

20. The cathode subassembly of claim 13, wherein the cathode subassembly has an X-dimension between one inch and two inches and a Y dimension between 0.5 inches and 1.25 inches.
